(19) United States
(12) Patent Application Publication
(10) Pub. No.: US 2024/0049688 A1
(43) Pub. Date: Feb. 15, 2024

(54) DEVICE AND METHOD FOR DETECTING, DISPLAYING AND EVALUATING MOTION DATA OF A HORSE

(71) Applicant: Cristiano ESTRADA, Düsseldorf (DE)

(72) Inventor: Cristiano ESTRADA, Düsseldorf (DE)

(21) Appl. No.: 18/258,208

(22) PCT Filed: Dec. 22, 2021
(86) PCT No.: PCT/EP2021/087181

§ 371 Date: Jun. 18, 2023

(30) Foreign Application Priority Data
Dec. 30, 2020 (DE) 10 2020 135 110.0

(51) Int. Cl. A01K 29/00; G01D 21/02

(52) U.S. Cl. CPC A01K 29/005; G01D 21/02

(57) ABSTRACT

The present invention relates to a portable sensor device for a horse, comprising: a fastening device for attachment to a horse's leg, and at least one sensor unit for recording movement data of the sensor unit, and a receiving device for receiving the data from the sensor unit, and an evaluation unit for evaluating the data from the sensor unit received from the receiving device, with the at least one sensor unit being detachably attachable to the fastening device and wherein the evaluation unit has a detection unit for identifying the type of fastening device and the evaluation unit is configured to evaluate the data from the sensor unit depending on the type of fastening device. The invention further comprises a kit-of-parts and an associated method.

The present invention relates to a device and a method for recording movement data of a horse, as well as a parts set (kit-of-parts). In particular, it relates to a device and a method for recording, displaying and evaluating movement data of a horse.

DE 20 2018 101 080 U1 describes a sensor device that can be worn on the horse's hoof, with which the movement data of the horse's hoof can also be measured; analogue sensor devices are known from US 2008/0202445 A1 and US 2019/0133 086 A1, which also disclose movement sensors attached to the horse's hoof, whereby movement data is recorded and evaluated. Furthermore, US 2011/0218463 A1 discloses a sensor device that is attached to the horse's leg by means of straps or belts and can be read out or evaluated subsequently.

In the prior art, determining the movement data of a horse is only ever possible with complex and specially adapted sensor devices. In addition, the data can be recorded only in the immediate vicinity, often only in areas where there is network reception, and the evaluation of the data is possible, in particular due to the volume of data, only via a remote computer.

The object of the present invention is to provide a portable sensor device and a method for determining a movement profile of a horse via such a portable sensor device for a horse to determine the horse's movement, which can be used more flexibly. In particular, the object of the invention is to provide a portable sensor device for a horse to determine its movement, in which the acquisition of data from several horses is possible at the same time even over a greater distance, and the evaluation of the data is also possible when there is no network reception.

This object is achieved according to the invention by the features of claim 1. Advantageous configurations are specified in the dependent claims.

According to this, the object is achieved by a portable sensor device for a horse, in particular for determining the movement of the horse, comprising: a fastening device for attachment to a leg of a horse, and at least one sensor unit for recording movement data of the sensor unit, in particular movement data of the sensor unit in space, and a receiving device for receiving the data from the sensor unit, and an evaluation unit for evaluating the data received from the sensor unit by the receiving device, wherein the at least one sensor unit can be removably attached to the fastening device and wherein the evaluation unit has a detection unit for identifying the type of fastening device and the evaluation unit is set up to evaluate the data from the sensor unit depending on the type of fastening device, in particular the position of the sensor unit on the horse's leg.

The attachment means for attachment to a horse's leg is the support of the sensor unit. This is preferably a horse gaiter, jumping gaiter, hard-shell gaiter, neoprene gaiter, fetlock gaiter, transport gaiter, stable gaiter, a hoof bell or a fetlock boot. The sensor unit can be attached to the fastening device in a detachable manner. As a result, one sensor unit can be used with different types of gaiters. It can be attached using a velcro fastener or placed and secured in a recess in the gaiter according to the shape of the sensor unit, or attached to the gaiter with a clip.

Advantageously, the sensor unit comprises and/or is substantially formed from the following three main components. An outer sensor housing, an electronic sensor module inside the sensor housing and an electrical sensor module located inside the sensor housing and an electrical supply unit connected or connectable to the sensor module.

The sensor housing is ideally enclosed on all sides. Furthermore, the sensor housing has at least one opening element which is pivotably or displaceably mounted on the sensor housing and through which the sensor module and/or the supply unit can be accessed and removed or inserted. The opening element is locked in the closing position, in particular by mechanical means and/or is magnetically lockable. In one embodiment, the sensor housing has a front side and a rear side, as well as one or more edge sides. The sensor housing is usually at least partially made of a very light, impact-resistant material, such as a plastic, light metal (aluminium) or a mixture thereof.

The sensor module is understood to relate to in particular the entirety of the associated electronic components which are technically necessary for the acquisition and transmission of the desired values and data.

The supply unit consists essentially of a battery, a rechargeable storage battery or such a pack of several batteries or rechargeable storage batteries. The rechargeable battery and/or the rechargeable battery pack may be insertable in the sensor housing in a replaceable manner or may be permanently installed in the sensor housing, i.e. installed in a non-removable manner. In the latter case, the sensor housing has at least one plug connection and/or connection fields for connecting an electrical charging source.

Furthermore, in an advantageous embodiment, the sensor housing has, attached on the rear side facing inwards in or on the fastening device, a fixing element which is, in particular, at least one velcro element, at least one push-button or another releasable fastening means or comprises such a fastening means.

The terms “front”, “rear”, “inside” and “outside” refer here to the intended position of the fastening element (gaiter) and the sensor unit attached thereto or therein on the horse during normal forward movement in the intended, normal use, unless the context of the text necessarily indicates otherwise or if something different is expressly determined. Thus, “front” means in the direction of the head, “rear” means in the direction of the tail and “inside” means in the direction towards the adjacent leg, transverse to the direction of travel and, by analogy, “outside” means in the direction away from the adjacent leg, transverse to the direction of travel or a theoretical head-tail axis.

The sensor unit is designed to record movement data from the sensor unit, in particular movement data from the sensor unit in space. The sensor unit preferably has a gyroscopic sensor, an acceleration sensor, a magnetometer, a pressure sensor, a vibration sensor, a magnetic sensor and/or an optical sensor. A GPS sensor can also be included. A temperature sensor is preferably also included, which is set up to record the temperature of the horse and/or the ambient temperature. Also preferably included is a sensor for detecting the heart rate and/or the blood time volume, which is set up to detect the heart rate and/or the blood time volume of the horse.

The movement data of the sensor unit—and thus of the point on the horse's leg to which the sensor is fastened via the fastening device or gaiter—can be recorded in particular by the gyroscopic sensor and the acceleration sensor. The data, which are determined, for example, in a gaiter type such as a stable gaiter with a sensor unit in the upper area of the gaiter, differ from that of a sensor unit in a jumping gaiter when the sensor unit is attached in the lower area of the gaiter. In both cases, however, the data are movement data of the horse.

The data is received—preferably wirelessly—preferably in real time via the receiving device for receiving the data from the sensor unit.

The data from the sensor are preferably transmitted directly in real time to the receiving device without intermediate storage on the sensor. The receiving device is connected to the evaluation unit and makes the data available to the evaluation unit. The time multiplex method is preferably used here.

The evaluation unit for evaluating the data of the sensor unit received by the receiving device is preferably equipped with a processor and designed to be portable. The evaluation unit preferably has a screen. The evaluation unit particularly preferably has an input interface, for example a keyboard, a touch-sensitive screen, a selector switch, particularly preferably a rotatable selector switch.

The detection unit for identifying the type of fastening device serves to input the type of gaiter and thus the position of the sensor unit on the horse's leg. This detection unit can either be the input interface of the evaluation unit, via which the information regarding the type of gaiter is entered. The detection unit is preferably an input unit, in particular an input unit of the evaluation unit. Preferably, an on-screen drop-down menu is used from which the type can be selected, or a rotating menu via which the type can be selected. The detection unit preferably includes an RFID reader. The RFID transmitter is preferably attached to the fastening device, i.e. the gaiter, and can then be read by the RFID reader.

The RFID reader can be integrated, for example, in the evaluation unit and can read the RFID transmitter when the evaluation unit approaches the RFID transmitter. Preferably, the RFID transmitter can also be attached to the gaiter and the RFID reader can be designed integrally with the sensor unit. If the sensor unit is then clicked into the gaiter, the RFID reader in the sensor unit can read the RFID transmitter in the gaiter and thus receive the information—this information can then be transmitted to the receiving device and from there passed on to the evaluation unit. This can be done once in an initialization phase or regularly during the measurement process of the sensor unit. Additional information that can be entered is information regarding which leg (front, back, right, left) of the horse the sensor unit or fastening device or gaiter is attached to. It is also possible for this information to be entered via a selector switch. This selector switch can be provided on the sensor component or on the evaluation unit.

The evaluation unit is now set up to evaluate the data from the sensor unit depending on the type of fastening device, in particular the position of the sensor unit on the horse's leg. Since the position on the leg determines what the raw data determined for the individual movements of the horse look like, it is now possible to evaluate this data depending on the type of gaiter and thus, for example, to decide what gait the horse is in (walk, trot, gallop).

A sensor unit is preferably used, in particular for certain movements such as walking, trotting, galloping. This can be used to determine the simple fitness of the horse. More preferably, two sensors are used, particularly when it is desired to advance to a more precise technique, such as analysis while jumping. More preferably, four sensors are used, especially when it comes to analyzing the full accuracy and precision of advanced technique movements, such as for dressage. It is also conceivable to use six sensor units, with four attached to the gaiter on each leg and a further two sensor units on the hind leg in the higher area. For each gait, the angles on the front leg can be recorded and compared with the corresponding angles on the other front leg. The same goes for the joints on the hind leg. The corresponding joints on the hind leg are called the fetlock joint between the fetlock and the cannon bone, the hock joint between the cannon bone and the lower leg, and the knee joint between the lower leg and thigh.

Preferably, with two and/or four sensors, lameness can be detected, for example when there is an injury in one of the legs, by looking at the weight distribution, force and movement analysis, which is comparable to previous movements and the other three legs.

Also, in the case of a pregnant horse, the position of the foal and the movement of the foal can be detected to know when the horse is going to give birth—before it happens. The birth itself can be detected and then a corresponding message transmitted. The evaluation unit preferably takes into account the movement of the legs, with the horse turning while standing, the level of stress when lying down, how the legs are positioned when laying down and with this information about pattern movement and positioning it is determined when a foal is coming before it starts and before it emerges. A corresponding message is then preferably transmitted and the owner is notified, for example—preferably using the same offline technology in the mobile unit in order to send a text message, etc.

It is also possible to detect colic and transmit a corresponding notification before the horse's health condition seriously deteriorates. The evaluation unit is set up to recognize the patterns that are associated with an occurring colic. The movement of the hind legs can preferably be taken into account here, in particular when these legs hit the stomach. In addition, advantageously, whether the front right or left legs are moving (stress) and whether the horse turns, how many times in a given time and whether it lies on its stomach for at least a predetermined period of time can be taken into account. In this way, a message can be sent in good time that provides information on a colic condition in the horse.

It is particularly preferred when account is taken of which sensor is attached to which leg of the horse. It is further preferred when the horse on which the sensor unit is attached is also taken into account. It is thus possible to attach several sensor units to one horse or also to attach one or more sensor units to several horses. In this way, several horses can be monitored at the same time by means of one evaluation unit.

In an advantageous embodiment, the sensor unit can be provided with a memory element and temporarily store the data in this memory element. The data from the sensor unit can thus be stored in the memory element and preferably transmitted to the receiving device at a predetermined point in time. The data is particularly preferably transmitted upon request by the evaluation unit or the receiving device.

If more than one sensor is used, the sensors can be in a star network (i.e. they are set up as slaves and masters) or as a stand-alone sensor. For example, four sensors can preferably be set up as slaves in order to generate data and send these data to the master (receiving device with evaluation unit) for further analysis. It is also possible to set up three sensors as slaves and 1 sensor as a master. The master transmits the information or analyzes the information. When all sensors are set up as masters, each sensor transmits or analyzes the information.

The evaluation unit is preferably set up to continue working with the other sensors even if one sensor fails. In this case, the evaluation unit can particularly preferably send a message that the reception of the data from a sensor unit is restricted, is faulty or does not function at all.

The evaluation unit can preferably be connected to the sensor unit. The evaluation unit is therefore preferably integrally connected to the sensor unit and can analyze the data here. The sensor unit particularly preferably uses a standard such as 5G or intelligent narrowband technology such as LTE-M, NB-IoT to transmit the data to the evaluation unit, which is arranged in the cloud.

In an advantageous exemplary embodiment of the invention, a portable sensor device is provided in which the evaluation unit has an independent operating system. By virtue of this independent operating system, the evaluation unit is able to evaluate the data itself and does not have to transmit the data to the cloud—for example via a smartphone—in order to have the data evaluated there and then receive the result again. This means that no traffic between the smartphone/cloud/computer and back is necessary and it is also possible to do this evaluation in remote areas where there is no network connection.

In an advantageous exemplary embodiment of the invention, a portable sensor device is provided in which the receiving device is configured to receive signals from the sensor unit wirelessly via a first wireless interface, the receiving device being designed separately from the sensor unit. This first wireless interface is preferably based on LoRa or LoRaWLAN technology, in particular at 2.4 GHz. Most preferably, the first wireless interface is based on 5G or an intelligent narrowband technology such as LTE-M, NB-IoT, so that the data can be uploaded directly to the cloud and the evaluation unit is also provided in the cloud. This makes it possible to receive real-time data from multiple sensors at the same time, whereas with a Bluetooth connection it would be possible only to read one sensor at a time. Preferably a 2.4 GHz transmission is used by the 4 sensors to send the data in real time—it is preferably not stored in the sensors but is sent immediately to the mobile unit (receiving device). In another exemplary embodiment, a memory element is provided for temporarily storing the data.

In an advantageous exemplary embodiment of the invention, a portable sensor device is provided in which the evaluation unit is set up to evaluate the sensor data from more than one sensor unit at the same time, preferably from two, four or six sensor units. This enables more complex analyses to be carried out on one horse and parallel measurements and over-measurements on several horses. It is possible to monitor several horses at the same time with a single device.

In an advantageous exemplary embodiment of the invention, a portable sensor device is provided in which the evaluation unit is connected to the receiving device, a storage unit and a transmission device, and the evaluation unit is configured to receive sensor data from the at least one sensor unit from the receiving device and to store this data in the storage unit and/or to transmit wirelessly via the transmission device via a second wireless interface to a cellular network and/or a cloud. In addition to the sensor unit, the other elements separated from it around the evaluation unit (receiving device, storage unit, transmission device, first and second wireless interface) are preferably combined in a mobile device or a mobile unit. The evaluation unit with these additional elements, i.e. the mobile unit, is preferably smaller than 20 cm×10 cm×4 cm, in particular smaller than 17 cm×7 cm×3 cm. Alternatively, the evaluation unit can also be arranged in the cloud and a mobile unit can then be dispensed with.

Preferably, the mobile unit (receiver) collects the information from the sensor units and the type of attachment device and it is stored and processed in an operating system within the mobile unit (receiver). The mobile unit preferably has a Linux operating system that processes the information in an SQL database, for example in order to send it to a smartphone in compiled form and to display the results on the smartphone. The mobile unit also preferably has a Linux operating system in order to process the information regarding local algorithms and, if a status to be reported is determined, to react and take an action to indicate this status, for example on the physical mobile unit to trigger an alarm, to send SMS messages or initiate calls, to contact the smartphone, to send data via WiFi, etc. The mobile unit preferably has a communication range of up to 300 meters.

In this way it is possible, for example, to send messages via a second wireless interface, preferably 3G, 4G, 5G, LTE, Bluetooth, WiFi, when predetermined events occur. For example, SMS can be sent to predetermined numbers if specific limit values are exceeded by the monitored horses, or specific telephone numbers can be called. It is also preferably possible to establish a connection to the cloud, be it via WiFi or 3G, 4G, 5G, LTE and upload data in order to subject it to a more extensive analysis and to transmit the result to a predetermined telephone, for example, where the results can be displayed. It is also possible for the data to be sent to a smartphone via Bluetooth and displayed on it.

The mobile unit (receiver) with the local operating system, i.e. the evaluation unit, enables several sensor data sets (several horses) to transmit the information at the same time and carry out the actions described above. The mobile unit enables the display of each horse profile individually on the screen and can switch between them, preferably via a rotating selector switch or the touch-sensitive screens. With the mobile unit, multiple phones can receive the same information at the same time. The mobile unit also allows the connection of additional systems such as cameras, additional devices, sensors, RFID, Lara technology. All analyses are performed on the mobile device or sent to the smartphone. This makes it possible to carry out the calculations without traffic via a mobile network and a cloud in which the calculations would otherwise be carried out. As a result, the movement profile of the horse can be determined by evaluating the recorded data in the evaluation unit without additional computing capacity.

The object is also achieved by a method for determining a movement profile of a horse using a portable sensor device according to one of the preceding claims, wherein
the sensor unit is attached to the fastening device
the type of fastening device is detected via the detection unit
the evaluation unit evaluates the data from the sensor unit depending on the type of fastening device and
this determines the movement profile of the horse.

The object is also achieved by a kit-of-parts for a sensor device for determining a movement profile of a horse, consisting of a fastening device in the form of a gaiter, which has at least one velcro fastening strap for fastening to the leg of the horse, and a sensor unit, which is attached to the gaiter, wherein the sensor unit is designed for recording movement data, in particular movement data in space. In this case, the sensor unit has a fixing element, in particular a velcro element, on the underside, to which a counter-fixing element, in particular a counter-velcro element, for attaching the fixing element of the sensor unit is arranged in a complementary manner in the region of the at least one velcro fastening strap of the gaiter. This counter-fixing element is in particular attached to the outside of the gaiter:—
on at least one partial surface of the back of the at least one velcro fastening strap of the gaiter or
on at least one partial surface below the velcro fastening strap of the gaiter.

This method and use of the sensor unit and/or the kit-of-parts makes it possible for the first time to use sensor units for different types of gaiters and to be able to determine the movement profile of the horse with an evaluation unit independently of these different types. By detecting the type of fastening device, the exact location of the sensor unit is determined and it is therefore possible to adapt the evaluation accordingly. It is thus possible for the first time, independently of individual gaiters and sensors attached to them, to use these items universally according to the “mix and match” principle. As a result, the evaluation unit can determine the movement profile of one or more horses in parallel based on the information on the type of gaiter—and preferably on the leg to which the gaiter is attached. This preferably also makes it possible to determine the gait the horse is in at a given point in time, or whether it is lame, etc. This evaluation can be carried out in the evaluation unit itself. In addition, the evaluation can also be carried out on a remote computer or in the cloud.

Further details and advantages of the invention will now be explained in more detail using an exemplary embodiment illustrated in the drawings.

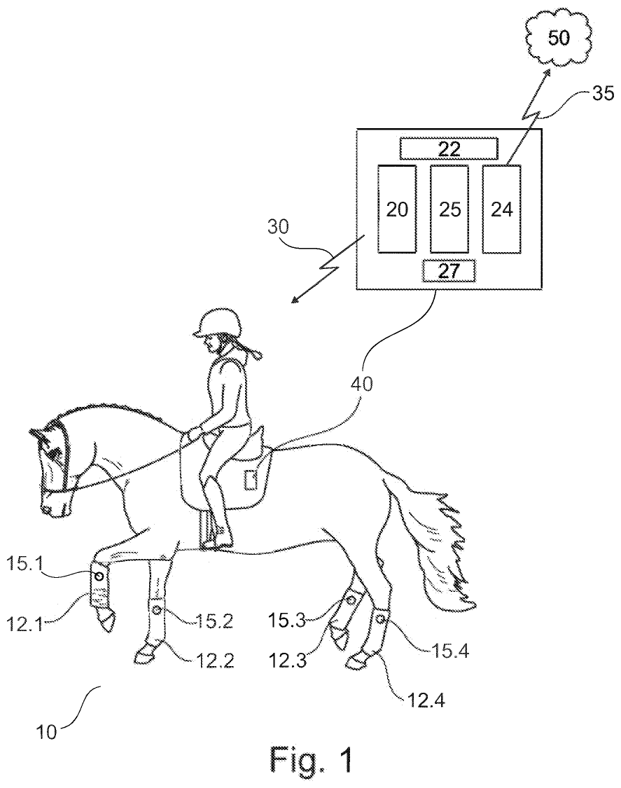

FIG. 1 shows a schematic representation of a portable sensor device;

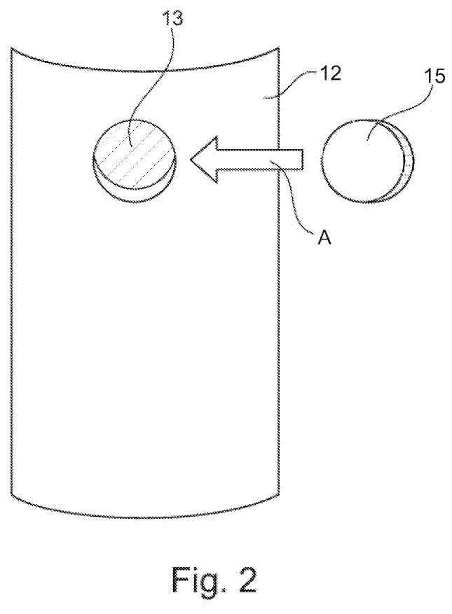

FIG. 2 shows a schematic representation of a gaiter and a sensor unit and

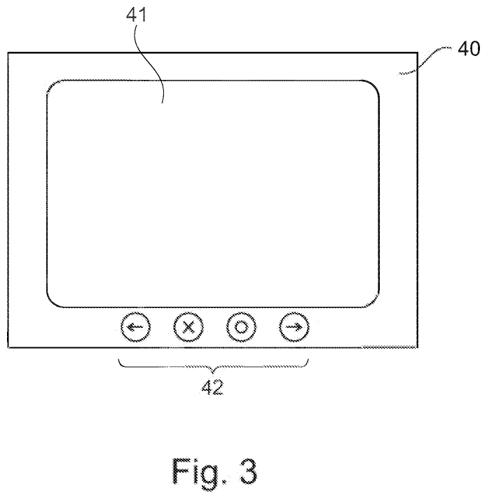

FIG. 3 shows a schematic representation of a mobile unit with screen and control buttons.

FIG. 1 shows a schematic representation of a portable sensor device 10 which is used on a horse. The portable sensor device 10 consists of a mobile unit 40 and sensor units 15.1 to 15.4 attached to gaiters 12.1 to 12.4. The mobile unit is attached to the saddlecloth and includes a first wireless interface 30, a receiving device 20, an evaluation unit 25, a memory 27, a detection device 22 for identifying the type of gaiter 12, a transmission device 24 and a second wireless interface 35. The first wireless interface 30 connects the receiving device 20 to the sensor units 15.1 to 15.4. The second wireless interface 35 connects the transmission device 24 to the cloud or the mobile network 50.

The sensor units 15.1 to 15.4 transmit the movement data to the receiving device 20 via the first wireless interface 30. A chip is preferably used here that provides a protocol built into the hardware (Enhanced ShockBurst protocol (ESB)). This allows 6 simultaneous connections to be established using the time multiplex method, of which in the FIG. 1 example four are used. When exchanging data, the master preferably sends a data packet to the slave, which is confirmed by the slave with Ack (data received). The master then switches to receive and the slave switches to transmit. A data packet is then sent from the slave to the master and the master responds with Ack (data received). The Enhanced ShockBurst protocol allows 32 byte payload to be sent with the Ack signal. This eliminates the need to switch from sending to receiving and almost double the usual data transfer rate is achieved.

The detection device 22 for identifying the fastening device 12 was used to input which sensor was attached to which type of gaiter and to which leg of the horse. The data from the sensor units 15.1 to 15.4 are then saved (interim) in the evaluation unit 25 depending on the data recorded in the recording device 22 regarding the type of gaiters and thus regarding the exact position of the sensor in relation to the horse's leg and in the memory unit 27. These results can then be read out, either via the evaluation unit itself or via a downstream device that can be addressed via the transmission device 24 and the second wireless interface 35.

This makes it possible to determine the movement data of a horse in real time and to read it in real time while the horse is moving and to incorporate this knowledge into the rider's own riding style. This is also possible if there is no network connection to a mobile phone network, for example, since the data volumes can be calculated directly in the evaluation unit, which has a Linux operating system for this purpose.

FIG. 2 shows a schematic representation of a gaiter 12 and a sensor unit 15. A recess 13 is provided in the gaiter, into which the sensor unit 15 can be inserted. This is done by inserting the sensor unit along the arrow A. The bottom of the recess 13 and the back of the sensor unit 15 are provided with appropriate velcro strips or velcro elements so that the sensor unit 15 is firmly attached to the gaiter 12 after insertion into the recess 13. Optionally, the inserted sensor unit can be covered again to protect it against soiling and falling out. In another embodiment, the recess 13 can be provided on the inside of the gaiter, so that when the gaiter 12 is attached, the sensor unit is again secured against falling out by being in contact with the horse's leg.

To avoid any negative influence on the movement, the sensor units 15 are primarily attached to the outside of the gaiter, i.e. in the walking direction of the animal and, when the gaiters 12 are attached as intended, on the right or left outside.

In a particularly advantageous embodiment, not shown, the sensor unit 15 has a velcro element on the rear side of the sensor housing and is mounted on the outside (facing outwards, transverse to the head-tail axis) of the gaiter 12, to which end a complementary counter-bonding element is arranged on the gaiter 12. Advantageously, the counter-closing element is dimensioned larger than the sensor housing of the sensor unit 15 at least in one direction, so that a protective and securing element, such as a leather or textile strip, can be attached so that it at least partially covers the sensor housing. The securing element itself also has corresponding counter velcro elements for attaching in the partial sections not covered by sensor element 15. Even though velcro connections are described here, which are particularly advantageous, alternative fastening means could be provided, such as straps with buckles, push buttons, etc.

In most types of gaiters, one or more velcro straps are provided for fastening to the horse's leg. These have the advantage of being light, secure in position and very flat. They are usually applied to the outside of the respective leg and thus fastened (closed). A further improvement thus consists of the counter velcro element for fastening the sensor unit 15 or the sensor housing being fastened on the outside, i.e. on the back/outside, of at least one velcro strap of the gaiter 12 and/or that on several velcro straps of a gaiter 12, in each case a section of a counter velcro element is arranged, on which together the sensor unit 12 can be fastened with the velcro element on the back.

Alternatively, the counter velcro element can be arranged at least partially (in the intended use) below at least one velcro strap of the gaiter 12, so that the sensor unit 15 is covered by the velcro strap of the gaiter 12 from the outside and additionally secured.

For the purposes of simplification, the term “velcro fastener strap” is used here, whereby this is generally constructed in several layers, consisting of at least one carrier strap, for example made of a fabric or leather, and the one part (hooks or eyes) of the actual velcro fastener element as well as, for example, damping or engagement elements or sections.

FIG. 3 shows a schematic representation of a mobile unit 40 with a screen 41 and control buttons 42. It is thus possible to view the data and evaluations on the mobile unit 40 on a screen and, if necessary, to make entries using control buttons 42. For example, the operating buttons can also be used to navigate in the menu in order to enter the type of gaiter and the affected leg of the horse.

With the portable sensor device according to the invention consisting of the remote sensors and an evaluation unit—be it as a mobile unit or in the cloud—it is possible to carry out an analysis of the movement data of the horse in real time, regardless of whether the sensor is in a jumping gaiter or housed in a stable gaiter. With this it is possible to switch the same sensor unit from one gaiter to another gaiter with the same configuration by the same user, whether this relates to the same horse or a different horse. It also does not matter if a mobile receiver unit is present or not, nor whether 5G technology or intelligent narrowband technology such as LTE-M, NB-IoT is being used. The possibility of a “mix and match” of sensor unit and fastening device, i.e. gaiter, is allowed for the first time by the invention. With this it is possible to configure a sensor that can be used for different gaiters and horses with the main/initial setup so that the user can put these on the horse and continue riding and not have to configure everything as a first-time setup.

### REFERENCE LIST

10 Sensor device
12 Fastening device/gaiter
13 recess on fastening device
15 sensor unit
20 receiving device
22 detection device for identifying the fastening device (12)
24 transmission device
25 evaluation unit
27 memory unit
30 first wireless interface between the sensor unit 15 and the receiving device 20
35 second wireless interface between the receiving device 20 and the mobile network or the cloud 50
40 mobile unit
41 display screen
42 control buttons
50 mobile network/cloud

1. A portable sensor device for a horse comprising:
a fastening device for attachment to a leg of a horse; and
at least one sensor unit for detecting movement data of the sensor unit;
a receiving device for receiving the data from the sensor unit; and
an evaluation unit for evaluating the data received from the receiving device that received the data from the sensor unit, the at least one sensor unit being detachably attachable to the fastening device;
wherein the at least one sensor unit is attachable to the fastening device with at least one Velcro fastener, and wherein the evaluation unit has a detection unit for identifying a type of the fastening device and the evaluation unit is set up to evaluate the data from the sensor unit based on the type of the fastening device.

2. The portable sensor device according to claim 1, wherein the fastening device is a horse gaiter, jumping gaiter, hard-shell gaiter, neoprene gaiter, fetlock gaiter, transport gaiter, stable gaiter, a hoof bell or a fetlock boot.

3. The portable sensor device according to claim 1, wherein the receiving device is set up to receive signals from the at least one sensor unit wirelessly via a first wireless interface, the receiving device being formed separate from the at least one sensor unit.

4. The portable sensor device according to claim 3, wherein the wireless transmission takes place via LoRa or LoRaWLAN technology, and wherein the wireless transmission is at 2.4 GHz and according to the 5G standard or an intelligent narrowband technology LTE-M or NB-IoT.

5. The portable sensor device according to claim 1, wherein the evaluation unit has an independent operating system.

6. The portable sensor device according to claim 1, wherein the evaluation unit is set up to evaluate the movement data from more than the at least one sensor unit at a time.

7. The portable sensor device according to claim 1, wherein the detection unit for identifying the type of fastening device is an input unit, wherein the detection unit is an input unit of the evaluation unit and comprises an RFID reader or has a selector switch.

8. The portable sensor device according to claim 1, wherein the evaluation unit is connected to the receiving device, a memory unit and a transmission device, and wherein the evaluation unit is set up to receive sensor data from the receiving device and from the at least one sensor unit and configured to store or record the data in the memory unit or to transmit the data wirelessly via the transmission device via a second wireless interface to a mobile radio network or a cloud.

9. The portable sensor device according to claim 8, wherein a movement profile of the horse can be determined by evaluating the recorded data.

10. The portable sensor device according to claim 1, wherein the at least one Velcro fastener is attached to a sensor housing of the at least one sensor unit.

11. A method for determining a movement profile of a horse via a portable sensor device, the method comprising:
using a fastening device for attachment to a leg of a horse, a sensor unit for detecting movement data of the sensor unit, a receiving device for receiving the data from the sensor unit, and an evaluation unit for evaluating the data received from the receiving device;
attaching the sensor unit to the fastening device;
detecting a type of the fastening device via a detection unit;
evaluating by the evaluation unit the data from the sensor unit based on the type of the fastening device; and
determining in the movement profile of the horse.

12. A kit for a sensor device for determining a movement profile of a horse, the kit comprising:
a fastening device comprising a gaiter, the gaiter having at least one Velcro fastening strap for fastening to a leg of the horse; and
a sensor unit configured to be attached to the gaiter;
wherein the sensor unit is configured to detect movement data in space, wherein the sensor unit has a fixing element in a region of the at least one Velcro fastening strap of the gaiter, a counter-fixing element for attaching the fixing element of the sensor unit, and wherein the counter-fixing element is attached outside of the gaiter; wherein the counter-fixing element is attached on at least one partial surface of a rear side of the at least one Velcro fastening strap or on at least one partial surface below the Velcro strap.

13. The kit according to claim 12, wherein the gaiter is a horse gaiter, jumping gaiter, hard shell gaiter, neoprene gaiter, fetlock gaiter, transport gaiter, stable gaiter, a hoof bell or a fetlock boot.

14. The kit according to claim 12, wherein the sensor unit comprises a gyroscopic sensor, an acceleration sensor, a magnetometer, a pressure sensor, a vibration sensor, a magnetic sensor, an optical sensor, a GPS sensor, and a temperature sensor wherein the temperature sensor is used for detecting temperature of the horse or an ambient temperature, and wherein the sensor unit includes a sensor for detecting heart rate or blood time volume.

15. The kit according to claim 12, wherein the sensor unit is configured to interact with a sensor device to be.
